(19) United States
(12) Patent Application Publication
(10) Pub. No.: US 2018/0093648 A1
(43) Pub. Date: Apr. 5, 2018

(54) BRAKE PEDAL EMULATOR OF A BRAKE-BY-WIRE SYSTEM

(71) Applicant: GM GLOBAL TECHNOLOGY OPERATIONS LLC, Detroit, MI (US)

(72) Inventors: Brandon C. Pennala, Howell, MI (US); Alan J. Houtman, Milford, MI (US); Paul A. Kilmurray, Wixom, MI (US); Christopher C. Chappell, Commerce Township, MI (US); Grant A. Browning, Brighton, MI (US); Robert J. Payton, JR., Fowlerville, MI (US); Jordan M. Krell, Royal Oak, MI (US)

(21) Appl. No.: 15/282,145

(22) Filed: Sep. 30, 2016

(51) Int. Cl. B60T 7/06; B60T 7/04

(52) U.S. Cl. CPC B60T 7/06; B60T 2270/82; B60T 7/042

(57) ABSTRACT

A brake pedal emulator extends and is connected between a support structure and a brake pedal along a centerline. The emulator includes a hydraulic cylinder, a piston head, and a variable flow communicator. An outer casing of the cylinder engages one of the structure and the pedal. The piston head engages the other of the structure and the pedal, and the communicator is carried between the casing and the piston head. A first chamber is defined at least in-part by the casing and a first side of the piston head, and a second chamber is defined at least in-part by the casing and an opposite second side of the piston head. The piston head is in sealed and slides with respect to the casing, and the communicator is adapted to provide fluid communication between the first and second chambers that varies with axial displacement of the piston head.

### FIELD OF THE INVENTION

The subject invention relates to a brake-by-wire (BBW) system, and more particularly, to a brake pedal emulator of the BBW system.

### BACKGROUND

Traditional service braking systems of a vehicle are typically hydraulic fluid based systems actuated by a driver depressing a brake pedal that generally actuates a master cylinder. In-turn, the master cylinder pressurizes hydraulic fluid in a series of hydraulic fluid lines routed to respective actuators at brakes located adjacent to each wheel of the vehicle. Such hydraulic braking may be supplemented by a hydraulic modulator assembly that facilitates anti-lock braking, traction control, and vehicle stability augmentation features. The wheel brakes may be primarily operated by the manually actuated master cylinder with supplemental actuation pressure gradients supplied by the hydraulic modulator assembly during anti-lock, traction control, and stability enhancement modes of operation.

When a plunger of the master cylinder is depressed by the brake pedal to actuate the wheel brakes, pedal resistance is encountered by the driver. This resistance may be due to a combination of actual braking forces at the wheels, hydraulic fluid pressure, mechanical resistance within the booster/master cylinder, the force of a return spring acting on the brake pedal, and other factors. Consequently, a driver is accustomed to and expects to feel this resistance as a normal occurrence during operation of the vehicle. Unfortunately, the ‘feel’ of conventional brake pedals are not adjustable to meet the desires of a driver.

More recent advancements in braking systems include BBW systems that actuate the vehicle brakes via an electric signal typically generated by an on-board controller. Brake torque may be applied to the wheel brakes without a direct hydraulic link to the brake pedal. The BBW system may be an add-on, (i.e., and/or replace a portion of the more conventional hydraulic brake systems), or may completely replace the hydraulic brake system (i.e., a pure BBW system). In either type of BBW system, the brake pedal ‘feel’, which a driver is accustomed to, must be emulated.

Accordingly, it is desirable to provide a brake pedal emulator that may be adjustable and may simulate the brake pedal ‘feel’ of more conventional brake systems.

### SUMMARY OF THE INVENTION

In one exemplary embodiment of the invention, a brake pedal emulator extends and is connected between a support structure and a brake pedal along a centerline. The brake pedal emulator includes a hydraulic cylinder, a piston head, and a variable flow communicator. The outer casing is engaged to one of the support structure and the brake pedal. The piston head is engaged to the other of the support structure and the brake pedal, and the variable flow communicator is carried between the outer casing and the piston head. A first chamber is defined at least in-part by the outer casing and a first side of the piston head, and a second chamber is defined at least in-part by the outer casing and an opposite second side of the piston head. The piston head is in sealed and sliding relationship with the outer casing, and the variable flow communicator is constructed and arranged to provide fluid communication between the first and second chambers that varies with axial displacement of the piston head.

In another exemplary embodiment of the invention, a BBW system for a vehicle includes a brake pedal engaged to a support structure, and a brake pedal emulator. The brake pedal emulator is constructed and arranged to exert a reactive force upon the brake pedal when a pressure is applied, and includes a force induction device, a damping device, and a friction device. The force induction device is constructed and arranged to exert a first force of the reactive force upon the brake pedal that varies as a function of brake pedal travel. The damping device is constructed and arranged to exert a second force of the reactive force upon the brake pedal that varies as a function of at least brake pedal displacement rate. The friction device is constructed and arranged to exert a hysteresis force of the reactive force upon the brake pedal.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic plan view of a vehicle having a BBW system as one non-limiting example in accordance with the present disclosure;

FIG. 2 is a schematic of the BBW system;

FIG. 3 is a schematic of a brake pedal assembly of the BBW system;

FIG. 4 is a schematic of a second embodiment of the brake pedal assembly;

FIG. 5 is a perspective view of a third embodiment of the brake pedal assembly;

FIG. 6 is a cross section of an emulator of the brake pedal assembly of FIG. 5;

FIG. 7 is a cross section of a friction device of the emulator;

FIG. 8 is a cross section of a damping device of the emulator illustrated in an extended state;

FIG. 9 is a cross section of the damping device illustrated in a retracted state and during application of a brake pedal;

FIG. 10 is a cross section of the damping device illustrated in the retracted state and during release of the brake pedal;

FIG. 11 is a graph of a force profile of a force induction device of the BBW system as a function of brake pedal travel;

FIG. 12 is a graph of a damping coefficient profile of the BBW system; and

FIG. 13 is a cross section of a fourth embodiment of an emulator.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features. As used herein, the terms module and controller refer to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

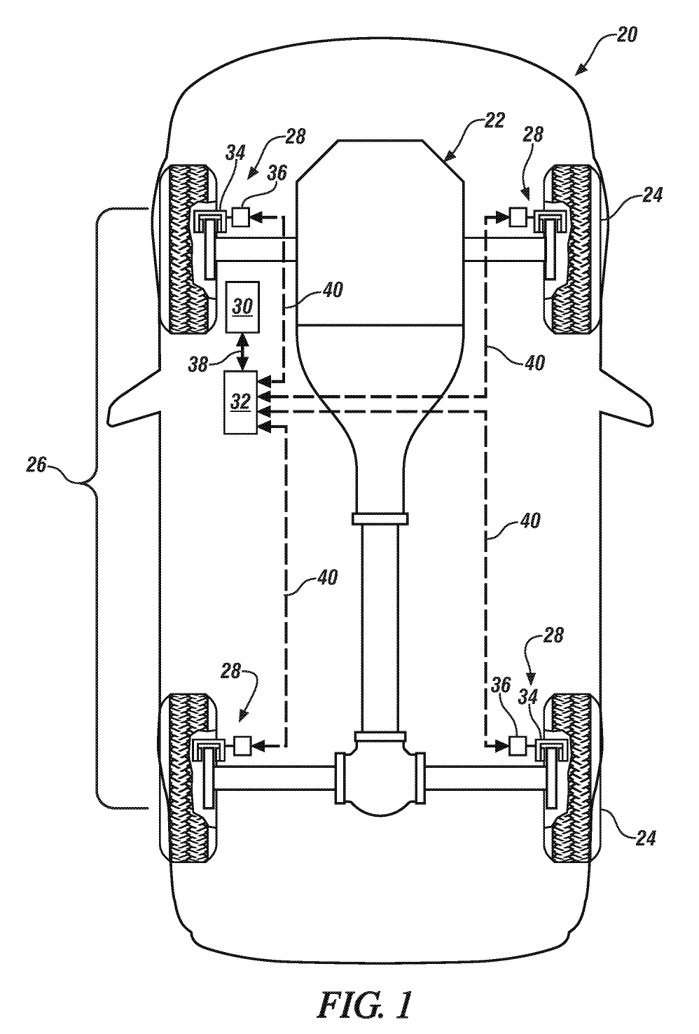

In accordance with an exemplary embodiment of the invention, FIG. 1 is a schematic of a vehicle 20 that may include a powertrain 22 (i.e., an engine, transmission and differential), a plurality of rotating wheels 24 (i.e., four illustrated), and a BBW system 26 that may include a brake assembly 28 for each respective wheel 24, a brake pedal assembly 30, and a controller 32. The powertrain 22 is adapted to drive at least one of the wheels 24 thereby propelling the vehicle 20 upon a surface (e.g., road). The BBW system 26 is configured to generally slow the speed and/or stop motion of the vehicle 20. The vehicle 20 may be an automobile, truck, van, sport utility vehicle, or any other self-propelled or towed conveyance suitable for transporting a burden.

Each brake assembly 28 of the BBW system 26 may include a brake 34 and an actuator 36 configured to operate the brake. The brake 34 may include a caliper (not shown) and may be any type of brake including disc brakes, drum brakes, and others. As non-limiting examples, the actuator 36 may be an electro-hydraulic brake actuator (EHBA) or other actuator capable of actuating the brake 34 based on an electrical input signal that may be received from the controller 32. More specifically, the actuator 36 may be or include any type of motor capable of acting upon a received electric signal and as a consequence converting energy into motion that controls movement of the brake 34. Thus, the actuator 36 may be a direct current motor configured to generate electro-hydraulic pressure delivered to, for example, the calipers of the brake 34.

The controller 32 may include a computer-based processor (e.g., microprocessor) and a computer readable and writeable storage medium. In operation, the controller 32 may receive one or more electrical signals from the brake pedal assembly 30 over a pathway (see arrow 38) indicative of driver braking intent. In-turn, the controller 32 may process such signals, and based at least in-part on those signals, output an electrical command signal to the actuators 36 over a pathway (see arrow 40). Based on any variety of vehicle conditions, the command signals directed to each wheel 24 may be the same or may be distinct signals for each wheel 24. The pathways 38, 40 may be wired pathways, wireless pathways, or a combination of both. Non-limiting examples of the controller 32 may include an arithmetic logic unit that performs arithmetic and logical operations; an electronic control unit that extracts, decodes, and executes instructions from a memory; and, an array unit that utilizes multiple parallel computing elements. Other examples of the controller 32 may include an engine control module, and an application specific integrated circuit. It is further contemplated and understood that the controller 32 may include redundant controllers, and/or the system may include other redundancies, to improve reliability of the BBW system 26.

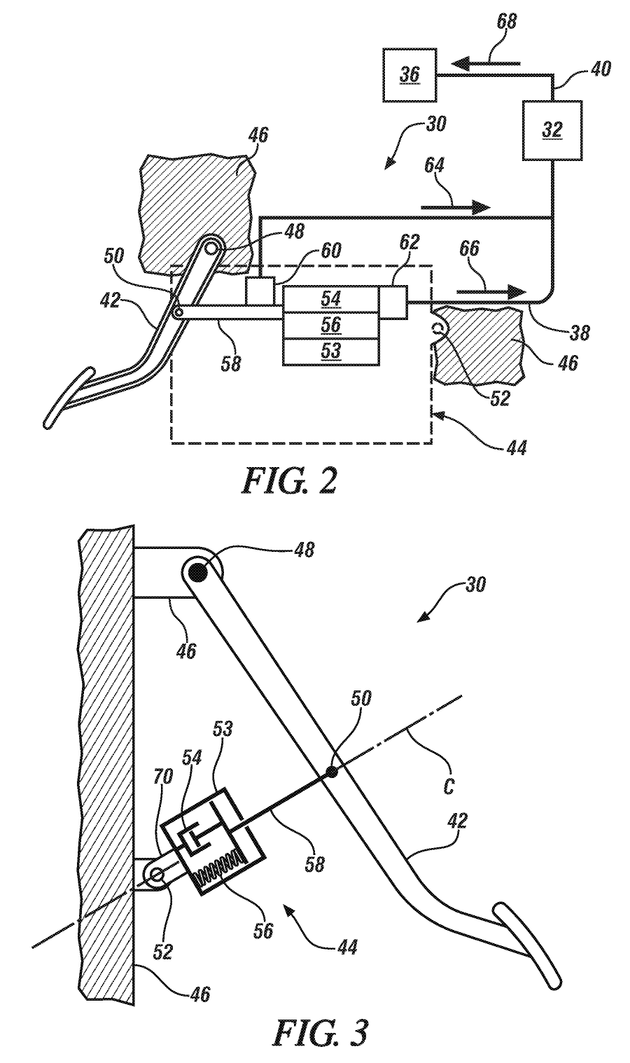

Referring to FIGS. 2 and 6, the brake pedal assembly 30 may include a brake pedal 42 and a brake pedal emulator 44. The brake pedal 42 may be supported by, and in moving relationship too, a fixed structure 46. Illustrated as one non-limiting example, the brake pedal 42 may be pivotally engaged to the fixed structure 46 about a first pivot axis 48. The emulator 44 may be a compact, single-coaxial, unit that is supported by and extends between the brake pedal 42 and the fixed structure 46. More specifically, the emulator 44 may be pivotally engaged to the brake pedal at a second pivot axis 50, and may be pivotally engaged to the fixed structure 46 at a third pivot axis 52. The second and third pivot axis 50, 52 may be spaced from the first pivot axis 48, and all three pivot axis 48, 50, 52 may be substantially parallel to one another.

Referring to FIGS. 2 through 4, the emulator 44 of the brake pedal assembly 30 may be a ‘passive’ emulator in the sense that the emulator 44 may not be directly or actively controlled by the controller 32, yet is configured to simulate the behavior and/or ‘feel’ of a more traditional hydraulic braking system. The emulator 44 may include a hysteresis device 53, a damping device 54 and a force induction device 56 to at least simulate a desired or expected ‘feel’ of the brake pedal 42 during operation by the driver. The hysteresis device 53 is constructed and arranged to generally facilitate a lag in a pedal return force when compared to the force applied by a driver. That is, when viewing a force versus pedal travel plot displaying a pedal return force curve and a pedal apply force curve, the hysteresis is the difference between the return and applied force at any particular location of pedal travel. The damping device 54 is constructed and arranged to generally produce a damping force that is a function of the speed upon which a driver depresses the brake pedal 42. The force induction device 56 produces an induced force (e.g., spring force) that is a function of brake pedal displacement.

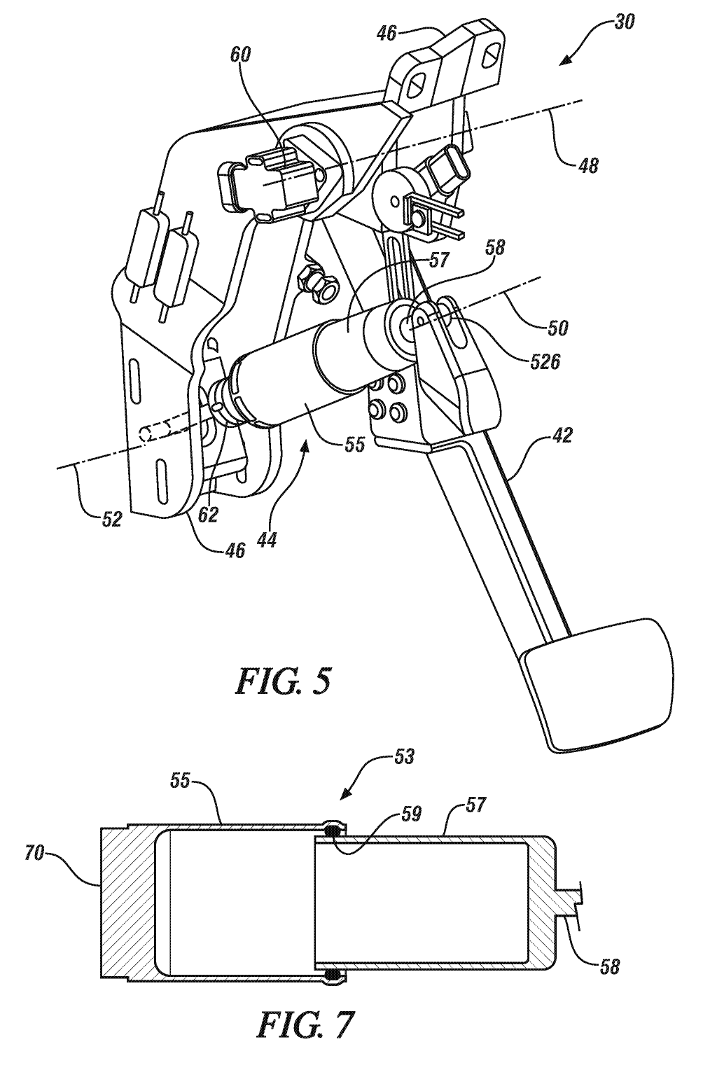

Referring to FIGS. 2, 5 and 6, the emulator 44 may further include a linking member 58 that operatively connects the brake pedal 42 to the devices 53, 54, 56 at the second pivot axis 50. A displacement sensor 60 of the emulator 44 is configured to measure displacement (e.g., linear or angular displacement) of at least one of the brake pedal 42 and the linking member 58. The emulator 44 may further include at least one pressure sensor 62 generally orientated at a reactive side of the devices 53, 54, 56 (i.e., proximate to the third pivot axis 52) to measure applied pressure (see FIGS. 2 and 6). It is contemplated and understood that the pressure sensor 62 may be a pressure transducer, a force sensing load cell integrated into a base member 70 of the emulator 44, or other suitable pressure sensor configured or adapted to precisely detect, measure, or otherwise determine an applied pressure or force imparted to the brake pedal.

Referring to FIG. 2, to optimize system reliability, the emulator 44 may include more than one displacement sensor 60 located at different locations of the brake pedal assembly 30. Similarly, the emulator 44 may include more than one pressure sensor 62 (i.e., force) configured to, for example, output redundant signals to more than one controller to facilitate fault tolerance for sensor faults. In operation, the controller 32 is configured to receive a displacement signal (see arrow 64) and a pressure signal (see arrow 66) over pathway 38 and from the respective sensors 60, 62 as the brake pedal 42 is actuated by a driver. The controller 32 processes the displacement and pressure signals 64, 66 then sends appropriate command signal(s) 68 to the brake actuators 36 over the pathway 40.

Referring to FIGS. 3 through 5, the emulator 44 of the brake pedal assembly 30 may further include a base member 70 pivotally connected directly to the fixed structure 46 about pivot axis 52. The hysteresis device 53, the damping device 54 and the force induction device 56 may generally be located between, and operatively bear upon, the base member 70 and the linking member 58. In operation, as the brake pedal 42 is depressed by a driver, the linking member 58 is generally moved closer to the base member 70 and the devices 53, 54, 56 are retracted and/or compressed there-between, creating the desired brake pedal ‘feel.’

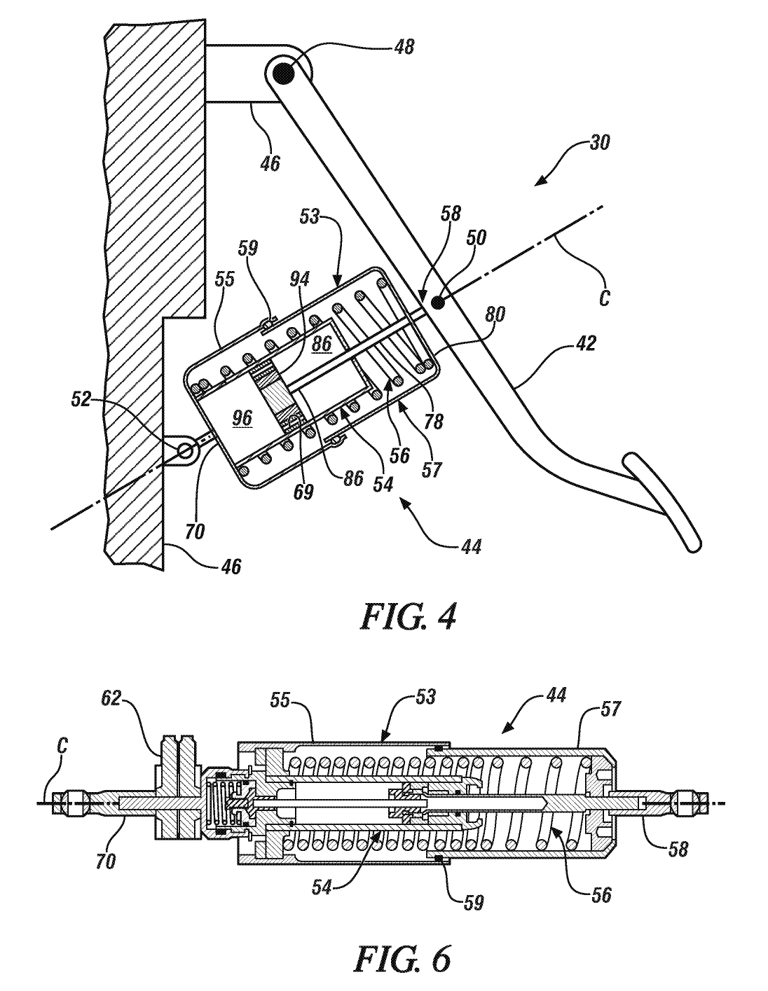

Referring to FIGS. 4 through 7, one example of a hysteresis device 53 may be a telescopic housing that may generally encase the devices 54, 56. The housing 53 may include first and second tubular components 55, 57 (e.g., cylinders) in telescopic relation to one another along centerline C, and a circumferentially continuous seal or o-ring 59 disposed radially and slideably between the components 55, 57. The first tubular component 55 may be rigidly fixed to and projects axially outward from the base member 70 and toward the pivot axis 50. The second tubular component 57 may be rigidly fixed to and projects axially outward from the linking member 58 and toward the pivot axis 52. In the present example, end portions of the components 55, 57 overlap one-another such that the first tubular component 55 is in-part located radially outward from the second tubular component 57.

In operation, the o-ring 59 is resiliently compressed radially between the tubular components 55, 57 thus producing a degree of friction and/or resistance toward displacement of the brake pedal 42 in either direction (i.e., pedal actuation and return). In one embodiment, the tubular components 55, 57 may not be true cylinders, and instead, at least one of the components 55, 57 may have a diameter (not shown) that changes as the component extends axially with respect to centerline C. In this embodiment, as the base and linking members 70, 58 move axially toward and away from one another with actuation of the brake pedal 42, the o-ring 59 becomes increasingly compressed or resiliently moves back toward a natural state. This variable force (i.e., biasing force by o-ring) exerted radially between the components 55, 57 by the o-ring 59 thus varies as a function of brake pedal displacement. This force profile represents the hysteresis.

Referring to FIGS. 3, 4 and 6, one example of the force induction device 56 may be a resiliently compressible, coiled, spring having opposite ends that bear upon the opposing base and linking members 70, 58. In operation, the force induction device 56 may exert a force that resists actuation of the brake pedal 42 and also facilitates the return of the brake pedal upon release by a driver. Other non-limiting examples of a force induction device 56 include an elastomeric foam, a wave spring, and any other device capable of producing a force generally as a function of brake pedal displacement.

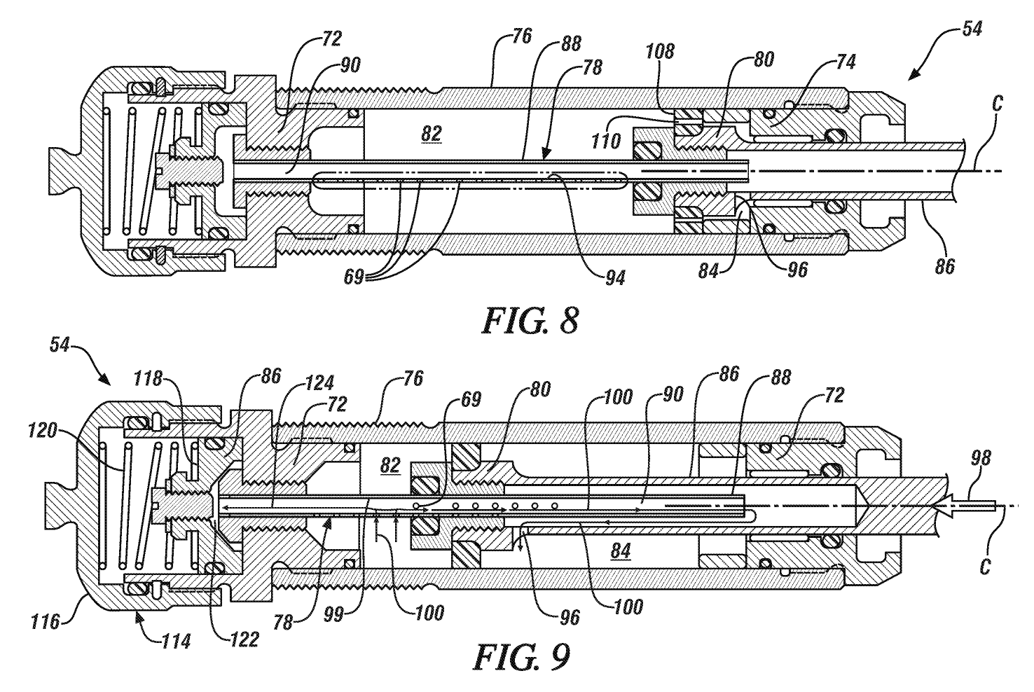

Referring to FIGS. 4, 6 and 8, the damping device 54 may be designed to exert a constant force when a constant speed or displacement rate is applied to the brake pedal throughout the brake pedal throw. One example of such a ‘constant force’ damping device 54 may be a hydraulic cylinder with an orifice or opening 69 (i.e., a flow communicator, see FIG. 4) for flowing hydraulic fluid and/or air. Another, non-limiting, example of a damping device 54 may include a device designed to increase a force with increasing pedal displacement and when the brake pedal 42 is depressed at a constant speed (see FIG. 8). Such ‘variable force’ damping devices may be passive and dependent solely upon the brake pedal position and/or displacement. One example of a ‘passive variable force’ damping device may include a hydraulic cylinder with multiple openings 69 individually exposed in succession depending upon the brake pedal position. Other non-limiting examples of a damping device 54 may include a friction damper, and any other device capable of producing a force generally as a function of pedal actuation speed. Although illustrated in a parallel (i.e., side-by-side) relationship to one-another (see FIG. 3), and illustrated in a concentric relationship to one-another (see FIG. 4), it is further contemplated and understood that the orientation of the devices with respect to one-another may take any variety of forms.

Referring to FIG. 8, the hydraulic cylinder example of the damping device 54 is illustrated in an axial expanded/extended state. In FIG. 9, the damping device 54 is illustrated in a compressed state. The damping device 54 may include a first wall 72, a second wall 74, an outer casing 76, a flow communicator 78, and a reciprocating piston head 80. The outer casing 76 may be circumferentially continuous about a centerline C, and may further be substantially cylindrical. The first and second walls 72, 74 are separated axially from one-another, and may generally be located radially inward, and engaged to, the outer casing 76. The piston head 80 is slideably sealed to the outer casing 76 and is adapted to axially reciprocate between the walls 72, 74.

A variable first chamber 82 of the damping device 54 includes boundaries generally defined radially by an axial portion of the outer casing 76, and axially between the first wall 72 and a first side of the piston head 80. A variable second chamber 84 (see FIG. 9) includes boundaries generally defined radially by another axial portion of the outer casing 76 and axially between an opposite second side of the piston head 80 and the second wall 74.

A piston rod 86 of the damping device 54 may be linked to and extends between the piston head 80 and the linking member 58. The flow communicator 78 may be part of a ‘passive variable force’ damping device that includes an axially extending, hollow tube 88 that defines an inner channel 90, and multiple openings 69 communicating through a wall 94 of the tube. The openings 69 may be distributed axially along the tube 88 such that a variable number of the openings 69 are in fluid communication between the first chamber 82 and the channel 90. The piston rod 86 and the tube 88 of the flow communicator 78 may axially overlap with the rod 86 located radially outward from the tube 88. It is further contemplated and understood that the openings 69 may be distributed in any variety of orientation capable of changing in flow cross section with axial movement of the piston head 80. In one embodiment, the opening 69 may consist of one axially elongated opening.

The piston rod 86 is constructed and arranged to have a sealed relationship with and slide axially through the second wall 74 that may be annular in shape. The piston rod 86 may include any variety of structural forms capable of connecting the piston head 80 to the linking member 58 while maintaining fluid communication between the second chamber 84 and the channel 90. For example and as illustrated, the rod 86 may be a hollow tube concentrically located about an axial portion of the tube 88, and having at least one port or opening 96 for fluid communication between the channel 90 and the second chamber 84. Similar to the annular second wall 74, the piston head 80 may be annular in shape. The tube 88 of the flow communicator 78 may be constructed and arranged to have a sealed relationship with, and generally slide axially through, the piston head 80.

Referring to FIG. 9, and in operation of the damping device 54, as the brake pedal 42 is applied by a driver (see arrow 98), the piston head 80 moves toward the left (i.e., from the perspective of the illustration), the overlap between the tube 88 and the piston rod 86 increases, and the first chamber 82 becomes smaller as the second chamber 84 becomes larger. During this volumetric change, a fluid (e.g., hydraulic fluid) flows (see arrows 100 in FIG. 9) from the first chamber 82, through a number of openings 69 of the flow communicator 78, and into the channel 90. From the channel 90, the fluid flows through the opening 96 in or proximate to the piston rod 86 and into the enlarging second chamber 84. With continued application of the brake pedal 42, the piston head 80 functions to cover and seal-off an increasing number of openings 69 causing a damping effect that may require a greater application of force to continue moving the piston head 80 toward the left (i.e., into the first chamber 82).

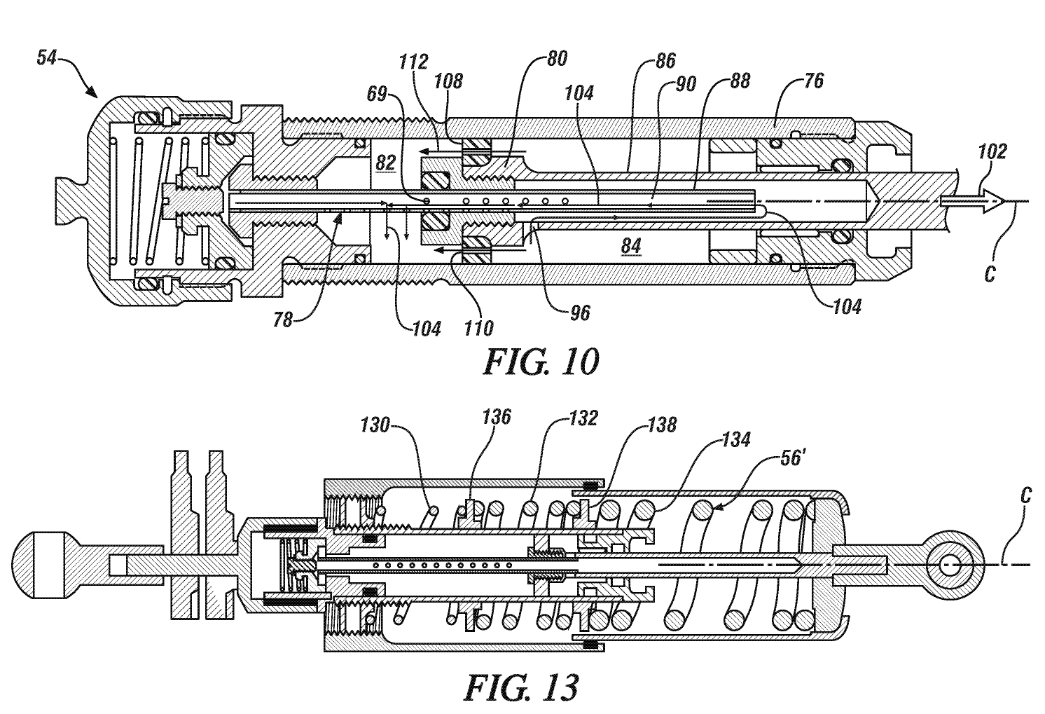

Referring to FIG. 10, and in operation of the damping device 54, after release of the brake pedal 42 and during pedal return (see arrow 102), the piston head 80 moves toward the right (i.e., from the perspective of the illustration), the overlap between the tube 88 and the piston rod 86 decreases, and the first chamber 82 becomes larger as the second chamber 84 becomes smaller. During this volumetric change, the fluid (e.g., hydraulic fluid) flows (see arrows 104 in FIG. 10) from the second chamber 84, through the opening 96, and into the channel 90. From the channel 90, the fluid flows through a varying number of openings 69 and into the enlarging first chamber 82. With continued return of the brake pedal 42, the piston head 80 functions to uncover and expose an increasing number of openings 69, further assisting return of the brake pedal 42.

As best shown in FIGS. 8 and 10, the piston head 80 may include a shim stack 108 that may be annular in shape for direct sliding contact with the outer casing 76. The shim stack 108 may be an integral part of, or otherwise include, a check valve associated with at least one axially extending opening 110 for intermittent fluid communication between the first and second chambers 82, 84. More specifically, during return of the brake pedal 42, the shim stack 108 may open due to a positive differential pressure across the piston head 80. With the shim stack 108 open, additional fluid may flow (see arrows 112 in FIG. 10) from the second chamber 84 and into the first chamber 82. Referring to FIG. 9 and as the brake pedal is applied, the differential pressure across the piston head 80 may be negative, causing the shim stack 108 to close.

Referring to FIG. 9, the damping device 54 may include an auxiliary chamber assembly 114 including a member 116 that may be an end cap, a floating head 118 and a spring 120 that may be a compression and/or coiled spring. An auxiliary chamber 122 that varies in volume may be defined axially between the floating head 118 and the first wall 72, and radially by the outer casing 76. The spring 120 may be axially disposed between the member 116 and the floating head 118. The floating head 118 may be sealed to and in sliding relationship with the outer casing 76. In operation, and with a high rate of force quickly applied to the brake pedal 42, the auxiliary chamber 122 may increase in volume with an influx of fluid (see arrow 124) against a biasing force of the spring 120.

Referring to FIG. 12, one example of a force profile of the force induction device 56 is generally illustrated as a function of brake pedal travel T, illustrated in the graph as driver applied brake pedal force F versus the brake pedal travel T. The solid arcuate or curved line 71 represents the targeted profile, and the dashed lines 73 represent the outer bounds (i.e., tolerance) of the targeted profile. The force induction device 56 may be designed to meet this targeted profile.

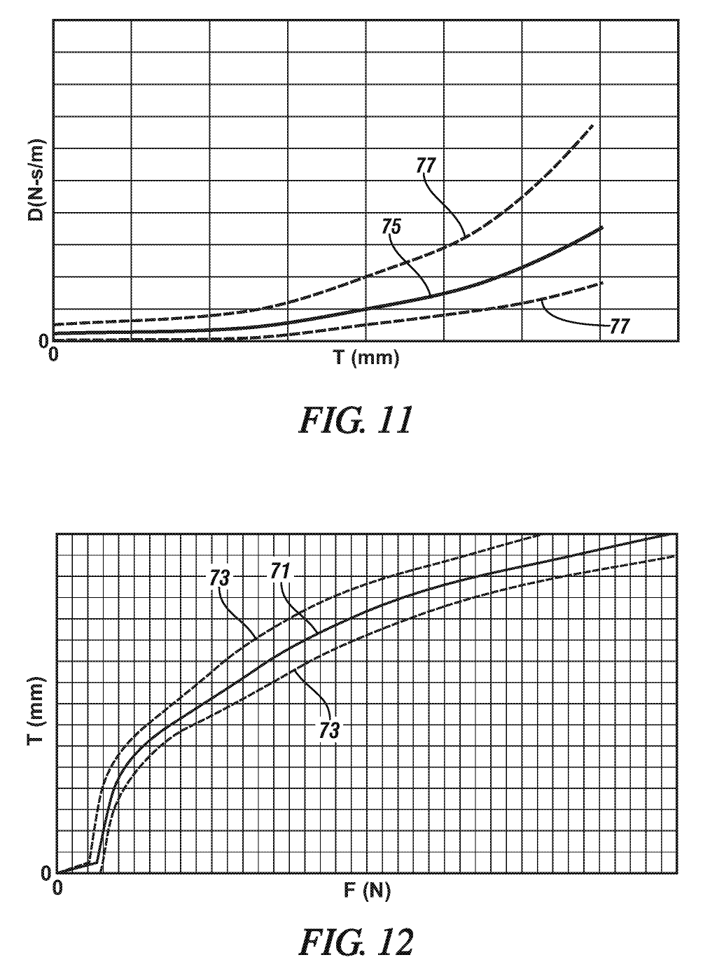

Referring to FIG. 11, one example of a damping coefficient profile is generally illustrated as a function of brake pedal travel T, illustrated in the graph as the brake pedal travel T versus a damping coefficient D. The solid arcuate or curved line 75 represents the targeted profile, and the dashed lines 77 represent the outer bounds (i.e., tolerance) of the targeted profile. Similar to the force induction device 56, the damping device 54 may be designed to meet this targeted profile. It is contemplated and understood that the data from the targeted force and damping profiles along with pre- established target tolerances (i.e., bounds) may be programmed into the controller 32 for various processing functions. It is further contemplated and understood that to various degrees, the damping device 54 may be adjustable with this adjustability being controlled by the controller 32 to, for example, meet the pre-programmed profiles of FIGS. 11 and 12. Yet further, the damping coefficient curve of FIG. 12 may be one of a plurality of damping coefficient curves each associated with an aspect of vehicle modeling. It is further noted that the damping coefficient D is a function of pedal position, and the damping force is a function of pedal apply rate and pedal position

Referring to FIG. 13, a second embodiment of a force induction device is illustrated wherein like elements to the first embodiment have like identifying numerals except with the addition of a prime symbol suffix. The force induction device 56′ of the second embodiment includes a plurality of coiled springs (i.e., three illustrated as 130, 132, 134) stacked axially along the centerline C, and at least one shuttle (i.e., two illustrated as 136, 138. Each shuttle 136, 138 may be generally annular in shape and constructed and arranged to move axially with respect to centerline C. When assembled, the first and second springs 130, 132 bear upon the first shuttle 136, and the second and third springs 132, 134 bear upon the second shuttle 138. Each spring 130, 132, 134 may have a unique or different spring constant that may be chosen to achieve a desired force profile curve based on brake pedal displacement.

Advantages and benefits of the present disclosure include a passive position dependent damping design, a hysteresis device that dual functions as a housing to protect the force induction and damping devices, a return damping relief feature that allows pedal return similar to vacuum boosted brake system, and a compact coaxial design for improved packaging. Other advantages may include a simulated brake pedal stiffness, damping and hysteresis similar to that of a vacuum boosted system. Yet another advantage includes a braking system capable of controlling brake pedal damping in real time, and a damping device that not only controls the magnitude of a damping force as a function of pedal speed, but may also control the damping force (i.e., damping coefficient) as a function of brake pedal travel to match a desired damping coefficient curve.

Although the emulator 44 has been previously described as ‘passive’ (i.e., not controlled by the controller 32), in other embodiments the emulator 44 may be, at least in-part, ‘active.’ For example, any one or more of the devices 53, 54, 56 may be active and thus generally controlled, individually or in combination, by the controller 32 to at least simulate the desired pedal ‘feel.’

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A brake pedal emulator extending and connected between a support structure and a brake pedal along a centerline, the brake pedal emulator comprising:
a hydraulic cylinder including an outer casing engaged to one of the support structure and the brake pedal, a piston head engaged to the other of the support structure and the brake pedal, and a variable flow communicator carried between the outer casing and the piston head; and
wherein a first chamber is defined at least in-part by the outer casing and a first side of the piston head, a second chamber is defined at least in-part by the outer casing and an opposite second side of the piston head, the piston head is in sealed and sliding relationship with the outer casing, and the variable flow communicator is constructed and arranged to provide fluid communication between the first and second chambers that varies with axial displacement of the piston head.

2. The brake pedal emulator set forth in claim 1, wherein the variable flow communicator includes a tube extending axially, spaced radially inward from the outer casing and in fixed association with the outer casing.

3. The brake pedal emulator set forth in claim 2, wherein the piston head is annular in shape for axial receipt of the tube.

4. The brake pedal emulator set forth in claim 3, wherein the hydraulic cylinder includes a second wall engaged to and disposed radially inward from the outer casing, and wherein the second chamber is defined axially between the piston head and the second wall.

5. The brake pedal emulator set forth in claim 4, wherein the variable flow communicator includes a series of openings distributed axially along and communicating through a wall of the tube.

6. The brake pedal emulator set forth in claim 5, wherein the hydraulic cylinder includes a first wall engaged to and disposed radially inward from the outer casing, and wherein the first chamber is define axially between the first wall and the piston head.

7. The brake pedal emulator set forth in claim 5, wherein the piston head is in sealed and sliding contact with the tube.

8. The brake pedal emulator set forth in claim 1 further comprising:
a telescopic housing co-extending axially with and concentrically disposed radially outward from the hydraulic cylinder, and wherein the telescopic housing is engaged to and extends between the support structure and the brake pedal.

9. The brake pedal emulator set forth in claim 8, wherein the telescopic housing includes a first tubular component engaged to one of the support structure and the brake pedal, a second tubular component disposed at least in-part radially inward from the first tubular component and engaged to the other of the support structure and the brake pedal, and a seal in sliding contact between the first and second tubular components.

10. The brake pedal emulator set forth in claim 9, wherein the seal is an elastomeric o-ring compressed radially between the first and second tubular components.

11. The brake pedal emulator set forth in claim 8 further comprising:
a force induction device engaged to and extending axially between the support structure and the brake pedal.

12. The brake pedal emulator set forth in claim 11, wherein the force induction device is a coiled spring.

13. The brake pedal emulator set forth in claim 12, wherein the coiled spring is disposed concentrically to and radially between the telescopic housing and the hydraulic cylinder.

14. The brake pedal emulator set forth in claim 1 further comprising:
a force induction device engaged to and extending axially between the support structure and the brake pedal.

15. The brake pedal emulator set forth in claim 14, wherein the force induction device is a plurality of coiled springs stacked axially and each including a different spring constant.

16. A brake-by-wire (BBW) system for a vehicle comprising:
a brake pedal operatively engaged to a support structure; and
a brake pedal emulator constructed and arranged to exert a reactive force upon the brake pedal when a pressure is applied, the brake pedal emulator including a force induction device constructed and arranged to exert a first force of the reactive force upon the brake pedal that varies as a function of brake pedal travel, a damping device constructed and arranged to exert a second force of the reactive force upon the brake pedal that varies as a function of at least brake pedal displacement rate, and a friction device constructed and arranged to exert a hysteresis force of the reactive force upon the brake pedal.

17. The BBW system set forth in claim 16, wherein the friction device is a telescopic housing disposed outward from and extending about the force induction device and the damping device.

18. The BBW system set forth in claim 17, wherein the force induction device is a coiled spring concentrically located between the telescopic housing and the damping device.

19. The BBW system set forth in claim 18, wherein the damping device is a hydraulic cylinder.

20. The BBW system set forth in claim 19, wherein the hydraulic cylinder extends along a centerline and includes an outer casing engaged to one of the support structure and the brake pedal, a piston head engaged to the other of the support structure and the brake pedal, and a variable flow communicator carried between the outer casing and the piston head, and wherein a first chamber is defined at least in-part by the outer casing and a first side of the piston head, a second chamber is defined at least in-part by the outer casing and an opposite second side of the piston head, the piston head is in sealed and sliding relationship with the outer casing, and the variable flow communicator is constructed and arranged to provide fluid communication between the first and second chambers that varies with axial displacement of the piston head.
